(19) United States
(12) Patent Application Publication
(10) Pub. No.: US 2018/0212369 A1
(43) Pub. Date: Jul. 26, 2018

(54) ELECTRICAL CONNECTORS FOR ZONE 2 HAZARDOUS LOCATIONS

(71) Applicant: James H. BULMER, Sherwood Park (CA)

(72) Inventor: James H. BULMER, Sherwood Park (CA)

(21) Appl. No.: 15/877,766

(22) Filed: Jan. 23, 2018

(30) Foreign Application Priority Data
Jan. 25, 2017 (CA) 2956033

(51) Int. Cl. H01R 13/703; H01R 13/53; H01R 24/20; H01R 24/28; H01R 13/625; H01R 13/622; H01R 13/62

(52) U.S. Cl. CPC H01R 13/7031; H01R 13/53; H01R 24/20; H01R 13/6205; H01R 13/625; H01R 13/622; H01R 24/28

(57) ABSTRACT

An electrical plug and receptacle can be connected and disconnected in the presence of explosive gas without causing a spark and possible explosion. Power is disconnected from the receptacle unless the plug is fully inserted and locked into position in the receptacle. A sensor detects when the plug is fully inserted and locked. The sensor energizes a relay which allows power to flow to the receptacle and the connected plug. The relay is encapsulated in epoxy or isolated in a Restricted Breathing enclosure to keep explosive gas away from the sparking relay contacts. To remove the plug from the receptacle, it must first be unlocked. The sensor detects the motion of unlocking the plug and releases the relay to disconnect power from the plug and receptacle so that no spark is created when the plug is removed from the receptacle. Ordinary NEMA plugs and receptacles can be used in Zone 2 and Class I Division 2 hazardous locations.

### TECHNICAL FIELD

This invention pertains to the field of electrical connections in hazardous locations where explosive gas may be present.

### BACKGROUND

Most electrical plugs and receptacles are rated for use in ordinary locations, where explosive gas is not present. A spark can occur if current is flowing from the receptacle to the plug when the plug is disconnected from the receptacle. In a similar fashion, a spark can occur when a plug is first inserted into a receptacle. The National Electrical Manufacturer's Association (NEMA) defines several standards for ordinary-location plugs and receptacles. These standards are followed by most manufacturers. NEMA plugs and receptacles for ordinary locations are readily available and inexpensive.

A spark that occurs upon connection or disconnection can cause an explosion if explosive gas is present. For that reason, NEMA plugs and receptacles rated for ordinary non-hazardous locations are not normally permitted in hazardous locations where explosive gas might be present.

There are known examples of Explosion-Proof electrical plugs and receptacles intended for use in hazardous areas. These connectors are designed to allow explosive gas to be present in arcing and sparking equipment. The connectors are built strong enough to contain the resulting explosion and prevent it from propagating outside the connector. However, these connectors are large, heavy, and expensive. U.S. Pat. No. 7,537,472 shows one example of an explosion-proof plug and receptacle typical of the prior art. U.S. Pat. No. 2,697,212 shows another example.

There are many known examples of electrical receptacles that keep power disconnected until a plug is inserted. U.S. Pat. No. 8,770,998 uses an optical sensor to detect when a plug is fully inserted, and a relay to energize the receptacle at that time. However, this receptacle is not safe for use in a hazardous location where explosive gas may be present. The relay contacts can create a spark upon opening and closing. Also, there is a race condition when the plug is removed. If the relay contacts have not completely opened before the plug prongs disconnect from the receptacle connections, a spark can occur. Either of these sparking conditions could cause an explosion if explosive gas is present. In addition, the plug is not locked into the receptacle, so unintended disconnection might occur and cause a spark.

U.S. Pat. No. 6,678,131 describes arc-safe electrical receptacles. This design uses a switch to detect the presence of the plug and a relay to connect power to the plug and receptacle. However, these receptacles are not safe for use in hazardous locations. The relay contacts and the switch can both create sparks that can ignite explosive gas. In addition, the plug is not locked into the receptacle, so unintended disconnection might occur and cause a spark.

U.S. Pat. No. 8,926,350 describes a protective lockable female electrical outlet. This design uses sliding contacts to energize the receptacle when a plug is inserted. It has the advantage of locking the plug into the receptacle to prevent unintended disconnection. However, the sliding contacts can create sparks that can ignite explosive gas.

U.S. Pat. No. 8,062,069 describes a spark-free improved connector. This design uses a reed switch controlled by a magnet attached to a plunger to disconnect power from the contacts before they are separated. This design would be safe for use in a location containing explosive gas. However, reed switches are able to carry only very small currents. This design is intended mainly for communication systems where the current through the connectors is low. This design would not be capable of carrying 15 to 30 Amperes as required for industrial power distribution in hazardous locations. Also, this design does not use standard NEMA plugs and receptacles.

U.S. Pat. No. 4,591,732 uses a light barrier to signal a relay when the plug is fully inserted into the receptacle. However, the relay contacts can create sparks that can ignite explosive gas. Also, there is a race condition when the plug is removed. If the relay contacts have not completely opened before the plug prongs disconnect from the receptacle connections, a spark can occur at the plug prongs. In addition, the plug is not locked into the receptacle, so unintended disconnection might occur.

U.S. Pat. No. 4,995,017 describes a safety electrical receptacle and claims to prevent explosions. It uses a triac to block power from reaching the receptacle terminals until a plug is fully inserted. However, this design would not be safe or acceptable in an atmosphere containing explosive gas. There are switches and contacts in direct connection to the high-voltage power line. Any of these switches or contacts could cause a spark and a potential explosion in the presence of explosive gas.

### SUMMARY

An electrical connector is disclosed comprising a receptacle having openings, a plug having blades that may be inserted into the openings in the receptacle, elements on the receptacle and on the plug having cooperating parts that create a first disengagement stage of the plug from the receptacle, in which removal of the blades from the openings comprises a second disengagement stage, a sensor arrangement sensitive to the first disengagement stage to produce a signal that energizes or de-energizes a relay; and the relay being responsive directly or indirectly to the signal to disable power to the electrical connector before the second disengagement stage, the relay having an isolation feature to prevent contact of explosive gas with a spark created by the relay.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 shows an electrical connector with a plug approaching a socket, the example shows a NEMA L21-30 twist-locking plug approaching a twist-locking receptacle;

FIG. 1A shows a blade of the plug with twist lock element;

FIG. 2 shows the electrical connector of FIG. 1 with the plug inserted in socket but not locked;

FIG. 3 shows an electrical connector with a plug locked in socket;

FIG. 4 is a front view of a threaded socket, the example shows a NEMA 5-15 electrical receptacle with male threads;

FIG. 5 shows a NEMA 5-15 electrical plug, with a locking nut attached, approaching the receptacle of FIG. 4, the locking nut having female threads to mate with the male threads on the receptacle;

FIG. 6 shows the electrical socket of FIG. 5 with fully inserted plug and tightly threaded socket;

FIGS. 6A and 6B show respectively an encapsulated relay 610 and a relay 610 in a restricted breathing enclosure;

FIG. 7 shows a wiring block diagram of the electrical connector of FIGS. 1, 2 and 3;

FIG. 8 shows a wiring block diagram of the electrical connector of FIGS. 4, 5 and 6, including microprocessor controlling the relay coil based on input signals from two magnetic sensors; and,

FIG. 9 shows a Timing Diagram 1 and FIG. 10 shows a Timing Diagram 2 showing the timing of signals for the system of FIGS. 7, 8, and 9, with Time on the X-axis and Voltage on the Y-axis, in which Timing Diagram 1 shows signal timing when the locking nut is being rotated clockwise to tighten it and Timing Diagram 2 shows signal timing when the locking nut is being rotated counterclockwise to loosen it, and in which a logic High level on the signal from a magnetic sensor indicates that a magnet has been detected within range of that sensor.

### DETAILED DESCRIPTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodologies, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

An electrical connector is formed of a plug and socket or receptacle. Design features are disclosed to allow an electrical connector to be freely connected and disconnected in a hazardous location where explosive gas might be present. The disclosed electrical connector may use, along with the design features, standard NEMA electrical plugs and receptacles, including twist-lock designs such as NEMA L21-30 and NEMA L5-15, and straight-blade designs such as NEMA 5-15 types.

The electrical connector with the design features is particularly intended for Zone 2 and Class I Division 2 hazardous locations where explosive gas may be present less than 10 hours per year. These hazardous locations comprise over 90 percent of the hazardous locations in most modern petrochemical facilities.

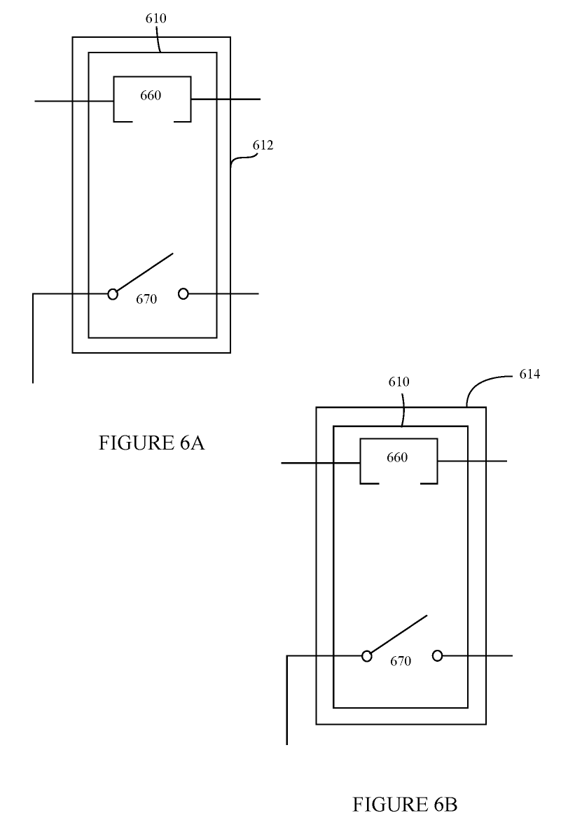

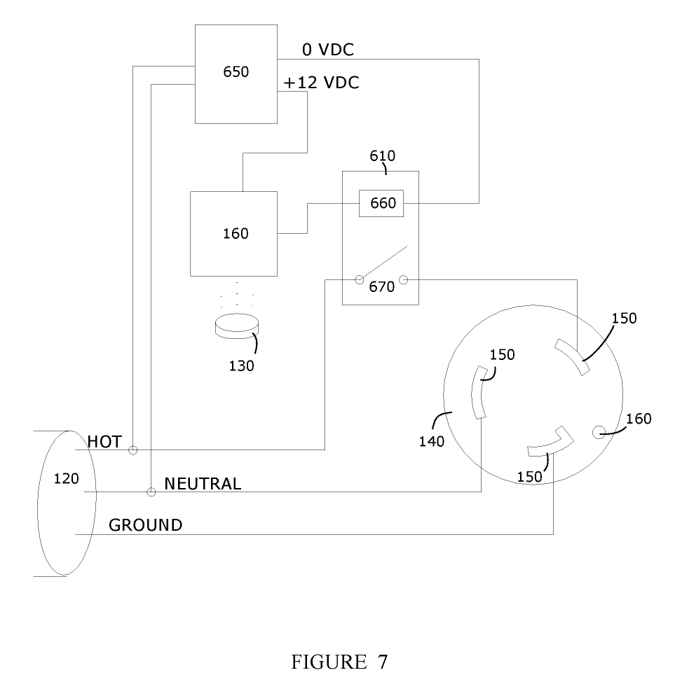

CSA Standard C22.2 No. 60079-15 Rule 20.1(a) defines the requirements for non-sparking plugs and receptacles in Zone 2 hazardous locations. The electrical connector has two stage design features that enable the electrical connector to meet this CSA standard. The electrical connector disconnects power from the receptacle unless the plug is fully inserted and locked into position in the receptacle. A sensor arrangement detects when the plug is fully inserted and locked. The sensor arrangement turns on a relay which allows power to flow to the receptacle and the connected plug. The relay is encapsulated in epoxy 612 (FIG. 6A) to keep explosive gas away from the sparking relay contacts or may be otherwise isolated from the explosive gas. This method of protection for hazardous locations is allowed under CSA Standard C22.2 No. 60079-15 Rule 29. Various methods may be used to produce an isolation feature to prevent contact of explosive gas with a spark created by the relay, using a material that forms a barrier between metal contacts of the relay and the explosive gas. FIG. 6A illustrates the relay coil and relay contacts encapsulated in epoxy schematically and in practice the components would be mounted on a circuit board that would also be encapsulated in epoxy.

Before the plug can be disconnected, it must be unlocked in a first stage of disengagement. The sensor arrangement detects the unlocking action and releases the relay to disconnect power from the plug and receptacle. The plug can then be removed from the socket in a second disengagement stage. No spark occurs at the connection between the plug blades and the receptacle contacts, because electrical power is not present at that connection at the moment of disconnection. Explosive gas is kept away from the spark that occurs at the relay contacts by epoxy that encapsulates the relay or another isolation feature.

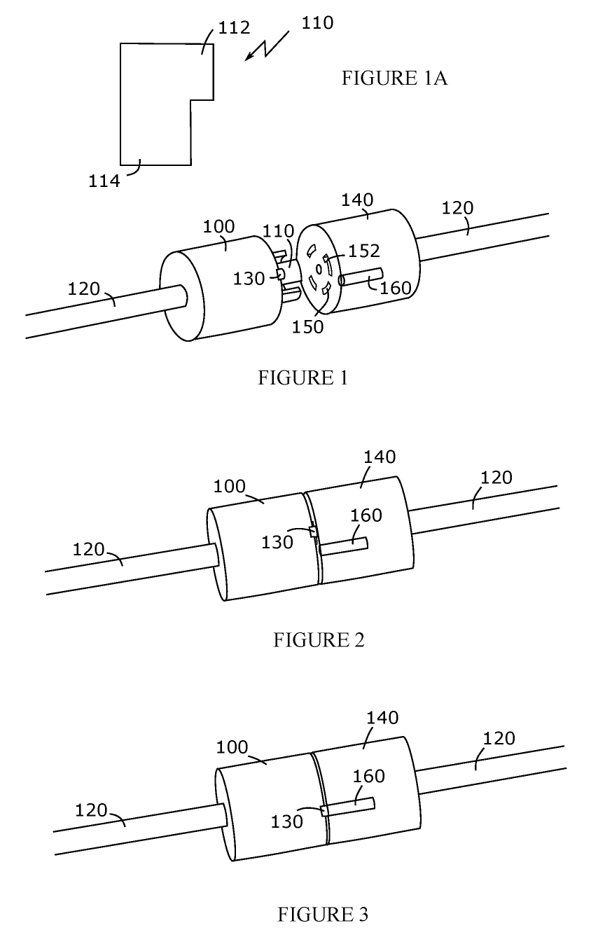

An electrical connector is shown in FIGS. 1, 2 and 3, with corresponding electrical block diagram of FIG. 7. In this embodiment, a locking plug and receptacle such as NEMA Type L21-30, Type L5-15, or other NEMA twist-locking type are used. The plug 100 locks into the receptacle 140 by inserting the plug 100 into the receptacle 140 as shown in FIG. 1 and FIG. 2, and then twisting the plug 100 clockwise with respect to the receptacle 140 to the position shown in FIG. 3. At least one and usually each of the blades 110 of the plug 100 have a head 112 that is longer in the circumferential direction than the stem 114 of the blade, as shown in FIG. 1A. The corresponding holes 152 in the receptacle 140 are enlarged in the same circumferential direction. These twist lock elements form cooperating parts on the plug 100 and receptacle 140 that create a first disengagement stage, with removal of the blades from the openings in the receptacle forming a second disengagement stage. The shoulder formed by the head creates a stop that abuts against a corresponding shoulder in the receptacle. The NEMA Type L21-30 electrical connector has these features. A permanent magnet 130 is installed into a hole near the face of the plug 100. A magnetic sensor 160 is installed into a hole near the face of the receptacle 140, the sensor 160 and permanent magnet 130 together comprise an example of a sensor arrangement. For this embodiment, a sensor that is sensitive to magnetic flux perpendicular to the face of the receptacle and insensitive to magnetic flux parallel to the face of the receptacle is preferred.

When the plug 100 is first inserted into the receptacle 140 to the position shown if FIG. 2, with its plug blades inserted in corresponding openings in the receptacle 140, the magnet 130 and the sensor 160 are mis-aligned such that the sensor 160 does not detect the presence of the magnet 130. In this condition, the sensor 160 does not energize the relay coil 660, the normally-open relay contacts 670 remain open, and the Hot contact 150 in the receptacle 140 remains de-energized. When the plug 100 is twisted clockwise to lock it in the receptacle 140 to the position shown in FIG. 3, the magnet 130 on the plug 100 moves into alignment with the magnetic sensor 160 on the receptacle 140. The sensor 140 detects this alignment and produces a signal to energize the relay coil 660 to close the relay contacts 670 and thus energize the contacts 150 in the receptacle 140 which are now connected to the blades 110 of the plug 100. Two distinct motions are required to insert the plug 100 into the receptacle 140, when the relay contacts 670 are open, and subsequently to twist the plug 100 to lock it into the receptacle 140, when the relay contacts 670 are closed. The receptacle contacts 150 and the plug blades 110 are not energized when they are joined together, so no arc or spark is caused. It is only after the plug 100 is locked in the receptacle 140 that the receptacle contacts 150, the plug blades 110, and therefore the tool or appliance are energized.

To unplug the tool or appliance, the plug 100 is twisted counterclockwise with respect to the receptacle 140 to unlock it in a first disengagement stage This action causes the magnet 130 in the face of the plug 100 to become misaligned with the magnetic sensor 160 in the face of the receptacle 140. The sensor 160 de-energizes the relay coil 660, which causes the relay contacts 670 to open. This de-energizes the receptacle contacts 150 and the plug blades 110. A separate action or disengagement stage is required to pull the plug 100 out of the receptacle 140. This action does not cause an arc, because the power to the contacts was disconnected during the unlocking action. This embodiment is safe for use in Zone 2 and Class I Division 2 areas containing explosive gas, because no spark is created upon connection or disconnection. As an added benefit, the twist-locking plug cannot be inadvertently disconnected from the receptacle. It requires two distinct motions to unlock and then remove the plug from the receptacle.

FIG. 7 shows a simplified wiring diagram for the system of FIGS. 1, 2 and 3. Cable 120 supplies electrical power to the receptacle 140. Neutral and Ground conductors from incoming cable 120 are connected directly to the corresponding terminals on the receptacle. The energized wire, also called the Hot wire, might for example be energized at 120 Volts AC. The Hot wire passes through a set of normally-open contacts 670 of relay 610 before it is connected to the Hot terminal on the receptacle. When the coil 660 of relay 610 is energized by placing a DC voltage across it, the contacts 670 close, which causes the Hot terminal of the receptacle to be energized. Magnetic sensor 160 energizes relay coil 660 when magnet 130 is detected within range of sensor 160. A power supply 650 converts AC voltage on the Hot and Neutral wires of cable 120 into DC voltage, for example 12 Volts DC, to supply power to the sensor 160 and the coil 660 of relay 610.

This embodiment will often be used on three-phase power systems. In that case there are three energized (Hot) contacts in the receptacle, and three encapsulated relays are used to de-energize the Hot receptacle contacts, with one relay controlling each phase.

In an alternate version of this embodiment, the relays are installed in a Restricted Breathing enclosure 614, shown schematically in FIG. 6B, another form of spark prevention feature. In practice, the Restricted Breathing enclosure will normally enclose the entire circuit board, with relay mounted on the circuit board. The Restricted Breathing enclosure performs the same function as the encapsulation of the relay and other electrical components on the circuit board. Both methods keep explosive gas away from the arcing relay contacts and thus prevent explosion if explosive gas is in the atmosphere. Both Restricted Breathing and Encapsulation are acceptable protection methods for arcing and sparking components in Zone 2 hazardous locations as defined in CSA standard C22.2 No. 60079-15.

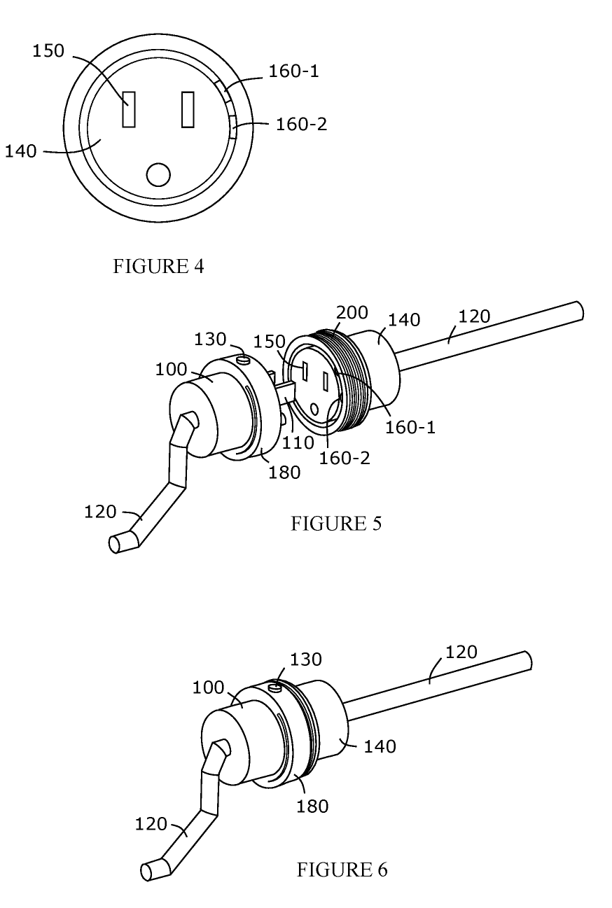

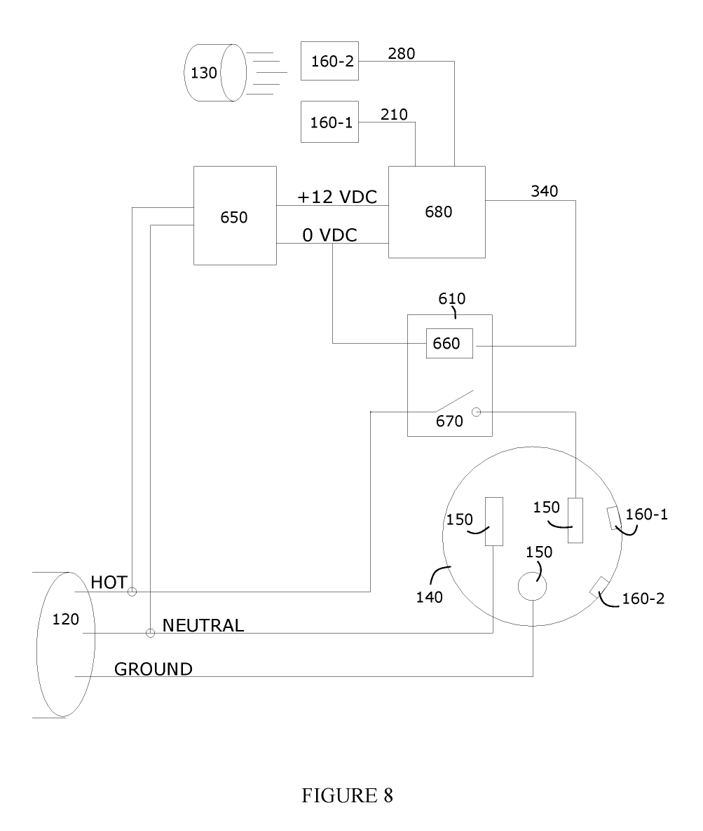

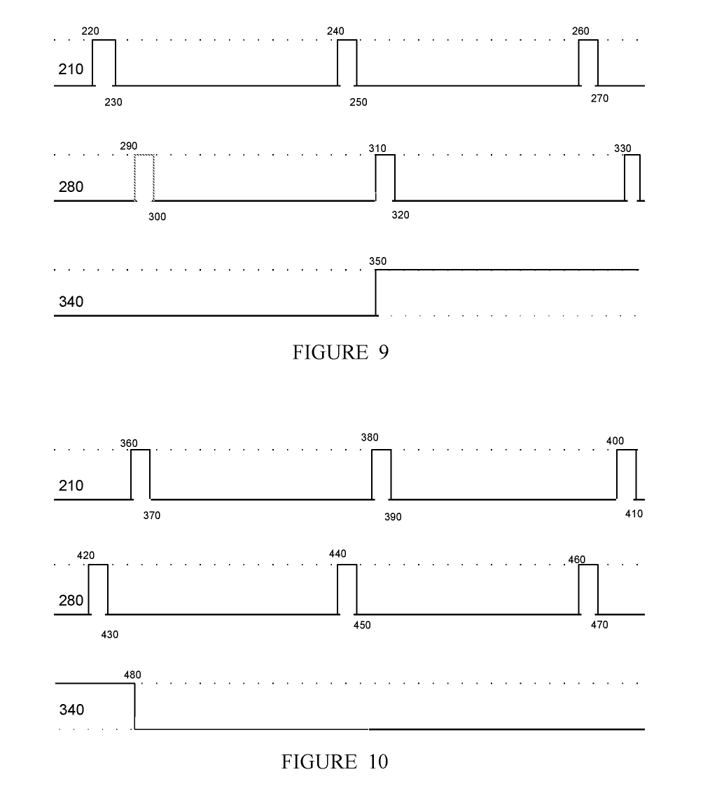

Another embodiment is shown in FIGS. 4, 5 and 6, electrical block diagram FIG. 8, and FIGS. 9 and 10 (Timing Diagrams 1 and 2). Referring to FIG. 5, a weatherproof NEMA 5-15 or other NEMA standard plug 100 has a captive nut 180 with internal threads which are tightened onto male threads 200 on the mating receptacle 140 to prevent water from entering the connection. The threads on the nut and the male threads 200 are designed such that the nut can rotate at least two full turns from completely loose to completely tight. The nut 180 is free to rotate around the plug 100, but has very limited range of motion forward and backward along the plug. A commercially available plug of this type is Leviton part number LNR80-1E. The mating threaded receptacle is Leviton part number LNR96-1. The threads and nut form cooperating parts that create a first disengagement stage. The nut may instead be placed on the receptacle with the exterior threads on the plug.

To modify the commercially available products for use in this embodiment, a permanent magnet 130 is embedded into the captive nut 180 on the plug 100, and two magnetic sensors 160-1 and 160-2 are embedded in the receptacle 140 near the male threads 200. FIG. 4 is a front view of the receptacle 140 that shows the approximate relative position of the two sensors 160-1 and 160-2 in the receptacle 140. The sensors 160-1 and 160-2 are approximately 20 degrees apart near the circumference of the receptacle threads 200. Sensor 160-1 is counterclockwise from sensor 160-2 in FIG. 4. Also shown in FIG. 4 are the contacts 150 in the face of the receptacle 140. The sensors 160-1 and 160-2 and the circuitry of FIG. 8, other than the relay 610, form a sensor arrangement that is sensitive to the positioning of the nut to energize the relay and allow power to flow in the electrical connector.

When the plug 100 is plugged into the receptacle 140 before rotation of the nut 180 to the position shown in FIG. 6, the receptacle contacts 150 and the plug blades 110 are de-energized because the relay contacts 670 are open. The captive nut 180 on the plug 100 must be tightened onto the male threads 200 on the receptacle 140 before the relay 610 is energized to close the relay contacts 670 and thus energize the receptacle contacts 150 and the plug blades 110.

On FIGS. 9 and 10, time is on the x-axis and voltage is on the y-axis. FIG. 9 shows the signal 210 from sensor 160-1, the signal 280 from sensor 160-2, and the signal 340 to the relay coil 660 of relay 610 at a time when the captive nut 180 is being tightened onto the male threads 200 to secure the plug 100 to the receptacle 140. The nut 180 is rotated clockwise to tighten. The magnet 130, secured to the nut 180, moves into alignment with sensor 160-1 at time 220, and the output signal 210 from sensor 160-1 goes High to indicate that the magnet 130 has been detected. Magnet 130 continues to move past sensor 160-1 until time 230 when magnet 130 is out of alignment with sensor 160-1, and signal 210 from sensor 160-1 goes Low to indicate that magnet 130 is not sensed. As the nut 180 continues to rotate clockwise, a short time later at time 290 the magnet 130 moves into alignment with sensor 160-2. Signal 280 from sensor 160-2 goes High to indicate that the magnet 130 has been detected. Magnet 130 continues to move past sensor 160-2 until time 300 when magnet 130 is out of alignment with sensor 160-2, and signal 280 from sensor 160-2 goes Low to indicate that magnet 130 is not sensed. In this way, a pulse from sensor 160-1 is followed a short time later by a pulse from sensor 160-2 when the nut 180 is tightened. This sequence is repeated starting at time 240 and again starting at time 260 as tightening continues. The difference between time 220 and time 240 and between time 240 and time 260 is the time required for one complete revolution of nut 180.

When the nut 180 has been tightened for at least one complete revolution, the engagement of the threads on the nut with the male threads on the receptacle makes it impossible to remove the plug from the receptacle. This condition occurs at time 240, and at this time it is safe to energize receptacle contacts 150 and plug blades 110, because they can no longer be disconnected to cause a spark. A microprocessor 680 is configured according to the timing diagrams of FIGS. 9 and 10 to detect the output of sensors 160-1 and 160-2 and determine direction of rotation of the nut 180. If the sequence of pulses indicates clockwise rotation of nut 180 as shown in signals 210 and 280, the microprocessor causes the coil 660 of relay 610 to become energized at time 240. This closes the relay contacts 670 to energize the receptacle contacts and plug blades, and thus the tool or appliance connected to the plug by cord 120 becomes energized.

At some time after time 240, clockwise rotation of nut 180 stops because the nut is tight. The microprocessor 680 stores the state of the relay coil output 340 in non-volatile memory and retains the relay coil output in the same High state until some later time when the nut is loosened. Power is allowed to flow to the tool or appliance as long as the nut is tight.

FIG. 10 shows the sequence of pulses from the two sensors 160-1 and 160-2 as the nut 180 is being loosened by rotating it counterclockwise. The magnet 130 embedded in the nut 180 moves into the detection range of sensor 160-2 at time 420, and the output 280 of sensor 160-2 changes to a High state. As the nut continues to rotate counterclockwise, the magnet 130 moves out of range of sensor 160-2 at time 430, and the output 280 of sensor 160-2 changes to a Low state. As the nut 180 continues to rotate counterclockwise, a short time later at time 360 the magnet 130 moves into alignment with sensor 160-1. Signal 210 from sensor 160-1 goes High to indicate that the magnet 130 has been detected. Magnet 130 continues to move past sensor 160-1 until time 230 when magnet 130 is out of alignment with sensor 160-1, and signal 210 from sensor 160-1 goes Low to indicate that magnet 130 is not sensed. In this way, a pulse from sensor 160-2 is followed a short time later by a pulse from sensor 160-1 as the nut 180 is loosened. This sequence is repeated starting at time 440 and again starting at time 460 as loosening continues.

In summary, when the nut is being tightened, sensor 160-1 emits a High pulse before sensor 160-2. When the nut is being loosened, the pulse sequence is reversed.

When microprocessor 680 detects the sequence of pulses on signals 210 and 280 that indicates loosening of nut 180 has begun as shown in FIG. 10, the microprocessor causes the coil 660 of relay 610 to become de-energized at time 480. This opens the relay contacts 670 to de-energize the receptacle contacts and plug blades, and thus the tool or appliance connected to the plug by cord 120 becomes de-energized. This occurs some time before the threaded ring is completely unthreaded from the receptacle. Power is removed from the receptacle and the plug before it is possible to remove the plug from the receptacle. Since the contacts are not energized when it is finally possible to separate the plug from the receptacle, no spark will be created. Sparks may occur inside the relay when the contacts are switched, but the relay is encapsulated in epoxy to keep explosive gas away from the spark. This embodiment is therefore safe for use in an area that may contain explosive gas.

FIG. 8 is an electrical block diagram for the system of FIGS. 4, 5 and 6. It shows the microprocessor 680 receiving signal 210 from sensor 160-1 and signal 280 from sensor 160-2. The microprocessor analyzes the pulse sequences from the two sensors, and determines whether the nut 180 is rotating clockwise, rotating counterclockwise, or stationary according to FIGS. 9 and 10. The microprocessor outputs signal 340 to control the relay coil 660 and thus the contacts 670 of relay 610. The relay contacts allow the Hot contact 150 of receptacle 140 to be energized according to signal 340 of FIGS. 9 and 10.

In an alternate version of this embodiment, the relay is installed in a Restricted Breathing enclosure. The Restricted Breathing enclosure performs the same function as the encapsulation of the relay. Both methods keep explosive gas away from the arcing relay contacts and thus prevent explosion if explosive gas is in the atmosphere. Both Restricted Breathing and Encapsulation are acceptable protection methods for arcing and sparking components in Zone 2 hazardous locations as defined in CSA standard C22.2 No. 60079-15.

In all embodiments, the magnetic sensor 160 may be replaced by a reflective optical sensor and the magnet 130 can be replaced by a reflector. A sensor arrangement may also use a reflective optical sensor, in which, in place of magnet, a reflector is used. The sensor detects light only when reflected back from reflector to sensor.

When a magnetic sensor is used in the sensor arrangement, a piece of steel may be used to steer away unwanted magnetic flux. The steel goes counterclockwise from the sensor, as seen from the plug end. It sits about as far from the magnet when the plug is unlocked as the sensor does, but in the opposite direction rotationally. Flux from the magnet will tend to move in the direction of the steel, not the sensor. As the plug is locked, the magnet moves away from the steel and toward the sensor. This should increase the discrimination of the sensor between unlocked and locked. It may be better to use a more sensitive sensor if the sensor is not as affected by stray flux. Equipment for use in hazardous locations must not produce sparks that can ignite explosive gas.

A system is described which allows extension cords and power cords from electric tools to be plugged into and unplugged from a power source without causing electrical arcs or sparks. This system will be particularly useful in permanent and temporary power installations on single-phase and three-phase circuits rated at 120 Volts AC or higher and 15 Amperes or higher in Zone 2 and Class I Division 2 hazardous locations.

The electrical connector may be used for inexpensive electrical plugs, receptacles and extension cords that are safe for use in Zone 2 and Class I Division 2 hazardous locations. Objectives and advantages of the disclosed embodiments may include one or more of the following:
a. 1) Electrical plugs, receptacles, and extension cords can be freely and safely connected and disconnected in Zone 2 hazardous locations, even under load.
   i. No electrical arcs and sparks are created when a plug is inserted and removed from a receptacle.
   ii. Industry-standard NEMA plugs and receptacles may be used with modifications such as disclosed. These NEMA devices are inexpensive and readily available.
   iii. Operation is safe in Zone 2 and Class I Division 2 hazardous locations where explosive gas might be present up to 10 hours per year.
   iv. Plugs and receptacles can be connected and disconnected without the need to determine if explosive gas is present. No special warning labels are required for use in hazardous locations.
   v. The requirements of safety certification standards such as CSA C22.2 No. 60079-15, C22.2 No. 60079-0, and C22.2 No. 213 may be met.
   vi. A receptacle is not energized unless a plug is fully inserted and locked into place.
   vii. The plug locks into the receptacle. Unintended separation is prevented. The action of unlocking the plug from the receptacle causes the power to be disconnected from the receptacle. Power is disconnected before the plug can be removed from the receptacle, so no spark is created.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

What is claimed is:

1. An electrical connector, comprising:
a receptacle having openings;
a plug having blades that may be inserted into the openings in the receptacle;
elements on the receptacle and on the plug having cooperating parts that create a first disengagement stage of the plug from the receptacle, in which removal of the blades from the openings comprises a second disengagement stage;
a sensor arrangement sensitive to the first disengagement stage to produce a signal that energizes or de-energizes a relay; and
the relay being responsive directly or indirectly to the signal to disable power to the electrical connector before the second disengagement stage, the relay having an isolation feature to prevent contact of explosive gas with a spark created by the relay.

2. The electrical connector of claim 1 in which the elements comprise cooperating stops on the plug and receptacle that form a lock, and the first disengagement stage comprises release of the lock.

3. The electrical connector of claim 2 in which the spark prevention feature comprises the relay being encapsulated in epoxy.

4. The electrical connector of claim 1 in which the spark prevention feature comprises a restricted breathing enclosure.

5. The electrical connector of claim 4 in which the relay is responsive to the signal from the sensor arrangement through a microprocessor.

6. The electrical connector of claim 1 in which the plug and receptacle comprise a twist lock plug and receptacle.

7. The electrical connector of claim 1 in which the cooperating parts comprise a nut with internal threads on one of the plug and receptacle and exterior threads on the other of the plug and receptacle, the nut being rotatable clockwise or anticlockwise.

8. The electrical connector of claim 7 in which the nut is on the plug and the external threads are on the receptacle.

9. The electrical connector of claim 7 in which the sensor arrangement comprises a magnet on one of the plug and receptacle and a magnet sensor on the other of the plug and receptacle.

10. The electrical connector of claim 9 in which the magnet sensor comprises a first sensor and a second sensor to enable determination of whether the nut has rotated clockwise or counterclockwise.

11. The electrical connector of claim 10 further comprising a microprocessor configured to determine whether the nut has rotated clockwise or counterclockwise by timing of signals from the first sensor and the second sensor.

12. The electrical connector of claim 1 in which the spark prevention feature comprises the relay being encapsulated in epoxy.

13. The electrical connector of claim 12 in which the spark prevention feature comprises a restricted breathing enclosure.

14. The electrical connector of claim 13 in which the relay is responsive to the signal from the sensor arrangement through a microprocessor.

15. The electrical connector of claim 1 in which the relay is responsive to the signal from the sensor arrangement through a microprocessor.
